(19) United States
(12) Patent Application Publication
(10) Pub. No.: US 2026/0010593 A1
(43) Pub. Date: Jan. 8, 2026

(54) TIME BASED FILE ACCESS

(71) Applicant: Dell Products L.P., Round Rock, TX (US)

(72) Inventors: Shiv S Kumar, Pune (IN); Anurag Sushil Chandra, Pune (IN)

(21) Appl. No.: 18/765,743

(22) Filed: Jul. 8, 2024

(51) Int. Cl. G06F 21/31; G06F 21/62

(52) U.S. Cl. CPC G06F 21/31; G06F 21/6218

(57) ABSTRACT

Time based file access credentials are disclosed herein. For instance authentication data representing a user identifier and a user password associated with the user identifier is received from user input associated with a user identity. In response to determining that the user identifier and the user password are valid and are associated with the user identity and based on first metadata associated the user identity, it is determined that the user identity is authorized to access storage server equipment associated with the authentication server. Furthermore, based on second metadata associated with data resources stored on the storage server equipment, it is determined that the user identity is permitted access to at least one data resource of the data resources.

### BACKGROUND

Credential-based file access refers to the security mechanisms to control access to files and resources based on user credentials, such as usernames and passwords, tokens, certificates, or other forms of authentication. This approach ensures that only authorized user identities can access sensitive information and perform specific actions on defined data, files, and/or directories.

Allowing any user to access any file any time leads to security issues, even for authorized users with system credentials, given that no users, or a limited number, require access to system files all the time. In this regard, as of today, credential-based file access is the main way users are granted access to files. For instance, a user is given permission to access a file, and if the user is authenticated, file access is granted. However, in some scenarios, legitimate user access is expected only at some specific times, e.g., during working hours, not around the clock, e.g., when a user is ordinarily sleeping.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a system for implementing time based file access, in accordance with various non-limiting example embodiments.

FIG. 2 depicts a method, flow chart, or time sequence, that implements time based file access, in accordance with various non-limiting example embodiments.

FIG. 3 illustrates a method, flow chart, or time sequence, that implements time based file access, in accordance with various non-limiting example embodiments.

FIG. 4 illustrates a method, flow chart, or time sequence, that implements time based file access, in accordance with various non-limiting example embodiments.

FIG. 5 illustrates a method, flow chart, or time sequence, that implements time based file access, in accordance with various non-limiting example embodiments.

FIG. 6 depicts permission, attributes, and time duration metadata used to implement time based file access, in accordance with various non-limiting example embodiments.

FIG. 7 depicts further permission, attributes, and time duration metadata used to implement time based file access, in accordance with various non-limiting example embodiments.

FIG. 8 illustrates additional permission, attributes, and time duration metadata used to implement time based file access, in accordance with various non-limiting example embodiments.

FIG. 9 depicts an illustrative scenario implementing a time based file access, in accordance with various non-limiting example embodiments.

FIG. 10 illustrates an elastic cloud storage (ECS) system, in accordance with various non-limiting example embodiments.

FIG. 11 illustrates a block diagram representing an illustrative non-limiting computing system or operating environment in which one or more aspects of various non-limiting embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As mentioned in the background, no user, or at least not every user, of a file repository needs to access file(s) from the file repository all the time. Example: A typical bank employee wants to access financial data for their customers, and thus has credentials usable at the bank to access the financial data. In this regard, the bank employee is expected to access the data only during office time, not outside of office time. For another example: A backup software user accesses data so that it may be backed up. However, the backup software user is expected to read the data only during the backup window, not all the time.

In this regard, credentials are one layer of security, however, as recognized in various example embodiments described herein, another layer of security can be time. As of today, if any user has been granted permission to access data, that user can access data irrespective of time using the user's credentials for a corresponding data storage system that stores the data. Unfortunately, this gives, to a malicious user, a large window to breach the security. However, with one or more embodiments described herein, even if the malicious user has broken credential security by surreptitiously learning the password, undergoing a dictionary attack, etc., time security can stop that user from accessing.

In this regard, even if the malicious user has obtained the authorized credentials for the user, if the file is not supposed to be accessed at the time, then access can be denied, or, at the very least, additional security procedure(s), such as one or more of multi-factor authentication (e.g., phone and/or email verification codes), secret questions and answers known only by the user, can be invoked to ensure that the accessing entity is the user and not the malicious user.

At a high level, files or directory can store allowed access time in metadata, which can be extended attribute of the given file or directory, or tracked in separate data structure accompanying the file or directory, e.g., mapping file ID of the file or directory ID of the directory to a temporal specification or range indicating at what times a given user is able to access the file or directory (and/or specifying what times the given user is prohibited from access).

After successful client authentication, the server would look for allowed access time and then proceed further or return ACCESS_DENIED based on the current server time.

In one or more example implementations, a new way is introduced in various embodiments to set “allowed access time” for files and directories. For example, the information can be stored at the file's or directory's extended attributes.

For example, whenever an authenticated client input/output (IO) request comes, a check can be performed if file or directory has an “allowed access time” attribute set. If not, the authentication can proceed further as it is done today for IO access. If the file does have the “allowed access time” attribute set, the current server time is obtained.

In this regard, the “allowed access time” is obtained from the file's or directory's extended attribute, and it is checked if the current time is within the “allowed access time”. If not, the IO is prohibited and an ACCESS_DENIED message is sent to the client. If so, authentication can proceed further as it is done today for IO access.

In case of file create/delete/rename to a directory, it is checked if the directory has “allowed access time” set. If not, authentication can proceed further as it is done today. If so, the current server time is obtained.

If the current server time is within the “allowed access time”, authentication proceeds further as it is done today. If the current server time is not within the “allowed access time”, an ACCESS_DENIED message is returned to the client. When “allowed access time” is set to a directory, the “allowed access time” can be relayed to all files and directories within the directory.

More generally, some aspects of credential-based file and/or resource access are authentication; authorization; use of access tokens, and the use of encryption. Authentication is the process of verifying the identity of a user identity and/or processor based equipment (e.g., user equipment, server based equipment, communications equipment, and the like. Common example methods can include: the most traditional form—username and password combinations; the combination of two or more authentication methods, such as passwords and one-time codes transmitted to a mobile device—multi-factor authentication (MFA); using finger prints, facial recognition, or other biometric data—biometrics; and using digital certificates issued by trusted verification authorities—certificates.

The key concepts of credential-based file and/or resource access are authentication; authorization; use of access tokens, and the use of encryption. Authentication is the process of verifying the identity of a user identity and/or processor based equipment (e.g., user equipment, server based equipment, communications equipment, and the like. Common example methods can include: the most traditional form—username and password combinations; the combination of two or more authentication methods, such as passwords and one-time codes transmitted to a mobile device—multi-factor authentication (MFA); using finger prints, facial recognition, or other biometric data—biometrics; and using digital certificates issued by trusted verification authorities—certificates.

Once authenticated, processor based equipment (e.g., server class multiprocessor machines, internet of things (IoT) devices, cloud based multiprocessor equipment, networking equipment, and the like) can determine the groups of actions a user identity (or where applicable, machine comprising one or more processor and/or one or more memory) is authorized or permitted to perform. Authorization is generally managed using access control lists (ACLs) that can define groups of user identities and/or collections of processing equipment that have access to defined resources such as files and/or directories, and the kinds of actions they are permitted to perform (e.g., read, write, and execute operations). Additional and/or alternative methods of authorization can role-based access control (RBAC) where user identities, and, where needed process based machinery, can be assigned defined roles and permissions can be assigned based on the defined roles rather than individual user identity. Example user identity and/or processor based machinery roles can be “system administrator,” “system user,” and the like.

Further, upon successful authentication, access tokens can be issued. These access tokens can comprise identity data associated with a user identity and permission data associated with the identity data. The access tokens can generally be used to verify access rights to resources without the necessity to repeatedly re-authenticate.

Also required for credential-based file access is the necessity for encryption where data, both in transit and at rest, is encrypted to protect it from unauthorized access. Only user identities with the correct credentials can decrypt and access the data.

Currently modern operating systems can use credential-based access control to protect files and directories. User identities must log in with valid credentials, and their access to files is typically governed by ACLs or RBAC. Further, cloud storage services can use credential-based access to ensure that only authorized users can access or share files. Cloud storage services often support the use of the open authorization (OAuth) protocol, an open source authorization protocol that standardizes access delegation and allows applications, via the use of OAuth tokens, to securely grant access to resources on disparate other web based services without the need to share authentication credentials. Additionally and/or alternatively, cloud storage services can also implement application programming interface (API) keys, unique identifiers that can be used to authenticate and authorize user identities, application developer identities, or software in execution that invoke or initiate an API. Nevertheless, API keys are typically used to authenticate and authorize a process management project with the API rather than human user identities. Further, cloud storage service can also use MFA for enhanced security.

A typical and illustrative scenario for the use of credential-based file access is in a corporate business entity environment, where employees access sensitive documents stored on shared network storage equipment. Generally, employees authenticate themselves using their corporate credentials (e.g., username and password) and in some instances might be required to use MFA. Based on their respective roles (e.g., human resources (HR), finance, information technology (IT), . . . ) they can be granted access to specific folders and files, wherein ACLs can define the permissions for each system, file or directory. On successful login, access tokens can then be issued. The access tokens can be used for subsequent system and/or file access requests during a session. Typically, file access is encrypted both when persisted on server storage equipment and during transmission over a communication network to prevent unauthorized access.

As will have been observed from the foregoing, currently most system equipment and/or file and/or directory access has been through credential-based access-a user identity is granted permission to access files and/or directories and in response to the user identity being authenticated, file or directory access is granted. However, there are situations where legitimate access (e.g., access by user identity and/or access by software in execution such as via API) is expected only at specific defined periods of time. For example, bank employees generally need access to customer banking data only during defined business hours (e.g., banking hours), not outside banking hours. Similarly a backup software user identity accessing data to backup generally will typically be expected to require access to the data during defined backup time windows (e.g., daily between 23:00 hours to 03:30 hours; during statutory holidays during 18:00 hours to 03:00 hours; and the like).

Credential-based authentication and access is currently the only layer of security provided for system (computing equipment) and system resource control (e.g., data persisted to server storage equipment, network resources, and the like), an additional layer of security, as detailed in this disclosure, can be accorded based on time (e.g., defined or definable time periods). The current existing situation is that user identities are granted and afforded permission to access data and/or system resources regardless of time. For example, a bank employee can access customer bank records 24-hours a day. Similarly, in the highly connected world of automated business and financial transactions, these transactions can be facilitated via multiple agent processes that can be in execution 24-hours a day/7 days a week/365 days a year.

The existing situation can therefore be subject to significant human initiated abuse, misappropriation/misuse of data, and/or malfeasance through, for example, the use of software in execution, intentionally designed to cause significant disruption to computing equipment, storage server equipment, communications equipment, networking equipment, infrastructures of national importance (e.g., oil-pipelines, electrical power grids, nuclear reactor facilities, etc.) controlled by interconnected communication and/or processing equipment, leak private information, gain unauthorized access to information or systems, deprive access to information, or which unknowingly interferes with computer security and privacy. Such software in execution can be categorized as malware (e.g., computer viruses, worms, Trojan horses, ransomware, spyware, adware, rogue software, wiper software intended to maliciously erase data from storage hardware or other static memory by deleting data and programs, and/or key-loggers that record/log the keys struck on computer keyboards, pin-pads, and/or touch-pads).

Since the extant credential-based authentication and access to resources accords access regardless of time, malevolent user identities and/or malicious software in execution can be accorded unlimited time windows within which to practice their malefaction. Even if a malefactor (e.g., human or software in execution) successfully breaches credential based security, time based security can introduce significant and additional impediments to the unauthorized and unfettered access to data resources and/or system resources.

At a high level the description set forth herein provides that resources, such as files or directories can be associated with metadata comprising a defined access time within which access can be accorded to authenticated user identities and/or applications in execution. Accordingly, once a user identity or application in execution has been authenticated using, for example, credential-based authentication processes, the user identity or application generally will not be granted permission to access the resources should the user identity or the application in execution attempt to gain access outside a defined time window. Thus, once the user identity or the application in execution has been authenticated using credential-based authentication processes the authentication equipment can determine, based on associated metadata, whether or not access to the resources should be conferred to the now currently authenticated user identity and/or currently authenticated application in execution. It is only when the user identity and/or application in execution has successfully been both authenticated via the credential-based authentication processes as well as has satisfied the time based time window requirement included in the metadata that the user identity and/or application in execution be allowed access to the resources (e.g., directory, files, and other hardware and/or software resources).

In instances where the user identity and/or application in execution attempts access to resources outside the defined time window, an ACCESS_DENIED notification can be generated and returned to the initiating user identity and/or initiating application in execution. It should be noted with regard to the defined time window, the granting of access to resources can be based on the time window can be determined based on a system clock associated with authentication equipment and/or one or more clocks synchronized with dedicated horological equipment (e.g., atomic clocks, . . . ).

Outlined below are example acts that can be performed by a system, such as authentication server equipment. These acts can comprise: in response to the authentication server having initially authenticated a user identity and/or application in execution using credential based authentication, the authentication server equipment, on referring to metadata comprising, for example, read, write, execute, and the disclosed time window attribute associated with an existing resource, can determine whether the user identity and/or application in execution can be granted further access to the existing resource at issue. In instances where the user identity and/or application in execution has successfully been authenticated by the authentication server using credential based authentication, but the attempt to access the existing resource is outside a prescribed and determined time window, the authentication server equipment can deny the user identity and/or application in execution access to the existing resource. In some embodiments, the authentication server equipment in response to determining that user identity and/or application in execution has attempted access to the existing resource outside the prescribed time window can generate and return an access denial message. In other embodiments, the authentication server equipment in response to determining that user identity and/or application in execution has attempted access to the existing resource outside the prescribed time window can remain silent (e.g., not acknowledging the failure to satisfy the time window constraint) but nevertheless noting to one or more error logs the failure of the user identity or application in executions attempted access to the existing resource at issue. As will be appreciated by those skilled in the art, the one or more error logs, where necessary, can be forwarded to system administrators for analysis and/or law enforcement for further investigation.

In instances where the user identity and/or application in execution, both satisfies the credential based authentication as well as the disclosed time based time window authentication, the user identity and/or application in execution can be allowed access to the existing resource.

In additional and/or alternative embodiments where there is a necessity by a user identity and/or an application in execution to create resources, delete resources, and/or rename resources (e.g., create directories and/or files, delete directories and/or files, rename directories and/or files), additional authentications can be required to accomplish these operations. On the understanding that the user identity and/or the application in execution has already been authenticated using credential based authentication and has also satisfied the time window criteria associated with gaining access and manipulating existing resources, there can be occasion where the user identity and/or application in execution attempts to create new resources, delete existing resources, and/or rename existing resources. In these instances, there can be one or more disparate defined time windows within which these operations can be performed. These disparate defined time windows can in included in metadata associated with the resource at issue as well as metadata associated with the user identity and/or the application in execution. Thus, authentication equipment can refer to the metadata associated with the resource at issue as well as the metadata associated with the user identity and/or application in execution to determine whether time window criteria have been fulfilled.

Where a user identity and/or application in execution is attempting to create a new resource, authentication equipment can typically use groups of metadata associated with the user identity and/or application in execution in order to ascertain whether the user identity and/or application in execution satisfies both the credential based authentication as well as the defined time window criteria needed to create the new resource. In response to the authentication equipment verifying that both the credential based authentication as well as the defined time window criteria have been fulfilled, the user identity and/or application in execution can be permitted to create the resource.

In response to the authentication equipment only being able verify that the credential based authentication has been fulfilled but the defined time window criteria has not been fulfilled, the authentication equipment can send an access denied message to the invoking or initiating user identity and/or application in execution, and thereafter can place an entry into an error log noting the date and time of the denial of access, the user identity and/or application in execution credential data, together with the access denial message generated and transmitted to the user identity and/or application in execution. As has been noted earlier, the authentication server in some embodiments may not transmit the access denied message to the user identity and/or application in execution, but the application server can nonetheless make a log entry of the denial of access event.

In instances where a user identity and/or application in execution is attempting to delete, modify, or rename an existing resource, authentication equipment can use the groups of metadata associated with the user identity and/or application in execution to determine whether the user identity and/or application in execution has satisfied the credential based authentication requirements as well as the defined time window conditions necessary to delete modify, or rename the existing resource. In instances where the user identity and/or application in execution have satisfied the authentication credential requirements and the user identity and/or application in execution is attempting to perform the deletion, modification, or renaming of an existing resource, within the defined time window allocated for the performance of the deletion, modification, or renaming of an existing resource, the authentication equipment can accord the user identity and/or application in execution permission to perform the operations needed to carry out the deletion, modification, or renaming of the existing resource. Conversely where the user identity and/or application in execution is unable to satisfy one of the authentication credential requirements and/or the access within the defined time window assigned for the performance of the performance of the deletion, modification, or renaming of an existing resource, the authentication equipment can generate and/or communicate to the user identity and/or application that they have been denied permission to perform the deletion, modification, or renaming of the existing resource. As has been observed earlier in regard to the authentication equipment denial of access events can be recorded to error logs without communicating notification of the denial of access. Further, as those of skill will appreciate the authentication equipment, in most embodiments will keep record of both successful authentication events and unsuccessful authentication events.

The disclosed systems and methods, in accordance with various embodiments, provide a system, apparatus, or device comprising: a processor; and a memory that stores executable instructions that, when executed by the processor, facilitate performance of operations comprising: obtaining, from user input associated with a user identity, authentication data representing a username and password combination, in response to determining that the username and password combination is valid and is associated with the user identity, determining, based on first metadata associated the user identity, that the user identity is authorized to access storage server equipment associated with the authentication equipment, and determining, based on second metadata associated with data resources stored on the storage server equipment, that the user identity is permitted access to at least one of the data resources.

Other operations comprise prior to determining that the username and password combination is valid, generating and transmitting, to a user device associated with the user identity, a first authentication code, and receiving, in response to the transmitting of the first authentication, a second authentication code that confirms that the username and password combination is valid, wherein the first metadata comprises one or more permissions for access to the data resources stored on the storage server equipment.

In regard to the foregoing, the second metadata can represent at least one defined time range during which the user identity is able to access the at least one of the data resources stored on the storage server equipment, and the at least one defined time range can be determined based on a quality of service metric data representative of a quality of service metric associated with the user identity. The at least one defined time range can be determined based on a historical pattern of use of the at least one of the data resources in association with the user identity, and the first metadata and the second metadata can be associated with the data resources stored on the storage server equipment.

In accordance with further embodiments, the subject disclosure describes a method, comprising a sequence of acts that can include: receiving, by an authentication server comprising at least one processor from user input associated with a user identity, authentication data representing at least one user access credential, in response to determining that the at least one user access credential is valid and is associated with the user identity, determining, based on first metadata associated the user identity, that the user identity is authorized to access storage equipment associated with the authentication server, and determining, based on second metadata associated with data resources stored on the storage equipment, that the user identity is permitted access to at least one data resource of the data resources.

Additional acts can include prior to determining that the at least one user access credential is valid, generating and transmitting, to a user device associated with the user identity, a first authentication code, and receiving, in response to the transmitting of the first authentication, a second authentication code that confirms that the at least one user access credential is valid.

Concerning the foregoing, the first metadata can comprise one or more permissions for access to the data resources stored on the storage equipment, and the second metadata can represent at least one defined time range during which the user identity is able to access the at least one of the data resources stored on the storage equipment. Further, the at least one defined time range can be determined based on a quality of service metric data representative of a quality of service metric associated with the user identity, the at least one defined time range can be determined based on a historical pattern of use of the at least one of the data resources in association with the user identity, and the first metadata and the second metadata can be associated with the data resources stored on the storage equipment.

In accordance with still further embodiments, the subject disclosure describes a machine-readable storage medium, a computer readable storage device, or non-transitory machine-readable media comprising instructions that, in response to execution, cause a computing system comprising at least one processor to perform operations. The operations can comprise: receiving, from user input associated with a user identity, authentication data representing a user identifier and a user password associated with the user identifier, in response to determining that the user identifier and the user password are valid and are associated with the user identity, determining, based on first metadata associated the user identity, that the user identity is authorized to access a storage device associated with the authentication server, and determining, based on second metadata associated with at least one file or at least one directory stored on the storage device, that the user identity is permitted access to the at least one file or the at least one directory.

Other operations can comprise, prior to determining that the user identifier and the user password are valid, generating and transmitting, to a user device associated with the user identity, a first authentication code, and receiving, in response to the transmitting of the first authentication, a second authentication code that confirms that the user identifier and the user password are valid.

With reference to the foregoing, the second metadata can represent at least one defined time range during which the user identity is able to access the at least one of the at least one file or the at least one directory stored on the storage device, the at least one defined time range can be determined based on a quality of service metric data representative of a quality of service metric associated with the user identity, the at least one defined time range can be determined based on a historical pattern of use of the at least one of the at least one file or the at least one directory in association with the user identity, and the first metadata can comprise one or more permissions for access to the at least one file or the at least one directory stored on the storage device, wherein the first metadata and the second metadata are associated with the at least one file or the at least one directory stored on the storage device.

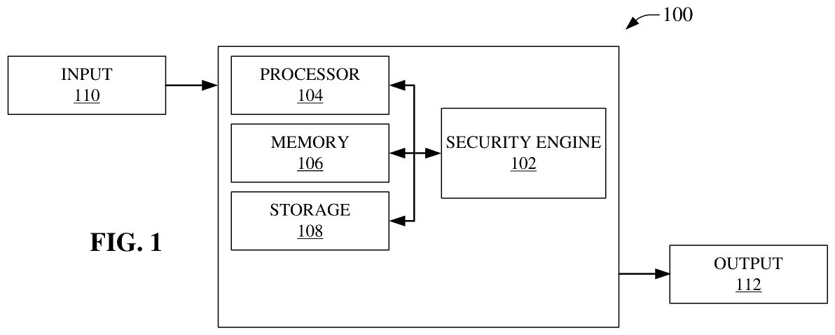

With reference to FIG. 1 that depicts a system 100 (e.g., authentication equipment, authentication server equipment, and the like) that can implement time based file access, in accordance with various non-limiting example embodiments. System 100, for purposes of illustration, can be any type of mechanism, machine, device, facility, apparatus, and/or instrument that includes a processor and/or is capable of effective and/or operative communication with a wired and/or wireless network topology. Mechanisms, machines, apparatuses, devices, facilities, and/or instruments that can comprise system 100 can include tablet computing devices, handheld devices, server class computing equipment, machines, and/or database equipment, laptop computers, notebook computers, desktop computers, cell phones, smart phones, consumer appliances and/or instrumentation, industrial devices and/or components, hand-held devices, personal digital assistants, multimedia Internet enabled phones, Internet of Things (IoT) equipment, multimedia players, and the like.

System 100 can comprise security engine 102 that can be in operative communication with processor 104, memory 106, and storage 108. Security engine 102 can be in communication with processor 104 for facilitating operation of computer-executable instructions or machine-executable instructions and/or components by security engine 102; memory 106 for storing data and/or computer-executable instructions and/or machine-executable instructions and/or components; and storage 108 for providing longer term storage of data and/or machine-readable instructions and/or computer-readable instructions. Additionally, system 100 can also receive input 110 for use, manipulation, and/or transformation by security engine 102 to produce one or more useful, concrete, and tangible result, and/or transform one or more articles to different states or things. Further, system 100 can also generate and output the useful, concrete, and tangible result and/or the transformed one or more articles as output 112.

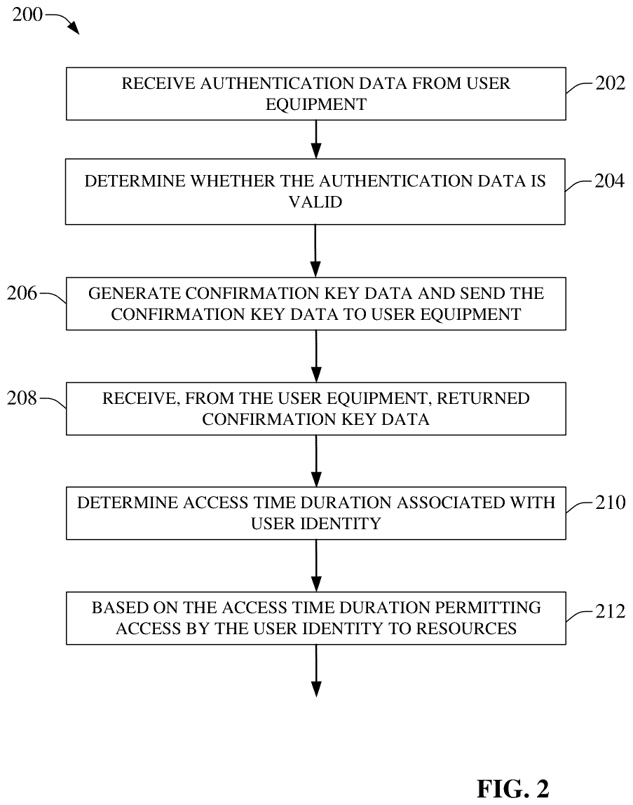

Now with reference to both FIGS. 1 and 2 that provides a methodology 200 for implementing time based file access, system 100 in collaboration with security engine 102, at act 202 of methodology 200, can receive as input 110 authentication data representative of at least one access credential. In some embodiments the at least one access credential can be username data (e.g., a user ID, login name, or screen name, a unique identifier assigned to a user identity for accessing a computer system, network, online service, or application). In additional and/or alternative embodiments the at least one access credential can be password data (e.g., a string of characters used for authenticating the user identity to access a system, application, network, or service). In some alternative embodiments, the at least one access credential can be a username and password couplet designed to ensure that only authorized user identities can gain access to specific resources. The username and password couplet is typically used in combination to verify a user identity. In response to determining that the at least one user access credential is valid and is associated with the user identity, at act 204, system 100 and security engine 102 can determine, based at least on first metadata associated with the user identity, that the user identity is authorized to access storage equipment associated with system 100.

At act 206 based on the user identity having been partially authorized to access the storage equipment associated with system 100, security engine 102 can generate and transmit to user equipment associated with the user identity a first authentication code (e.g., a pseudo-randomly determined string of alphanumeric characters of defined length-nonce string). In some embodiments, security engine 102, at act 206, can use one or more cryptographic techniques, such as hashing algorithms, wherein one or more of the attributes of the user identity can be used as a key. Use can also be made of multi-party block chaining algorithms, wherein data, such as the nonce strings, is encrypted using respective public/private cryptographic keys from at least three (or more) disparate devices, and the like.

The user equipment associated with the user identity can in some embodiments, return, at act 208, the pseudo-randomly determined string of alphanumeric characters unchanged. In other additional and/or alternative embodiments the user equipment associated with the user identity can regenerate a regenerated authentication code, based on the received authentication code, and based on group of mutually agreed rules that can have been established earlier between system 100 and the user equipment associated with the user identity, thereby providing a second authentication code which then can be returned to system 100, at act 208.

The regeneration of the authentication code to comprise the regenerated authentication code (e.g., the second authentication code) can be effectuated using, for example, the above noted hashing algorithms, wherein one or more alternate and/or additional distinct attributes associated with the user identity can be used as a key. As also observed above, use can be made of multi-party block chaining algorithms, wherein data, such as earlier generated nonce strings, can be encrypted using respective public/private cryptographic keys from a group of disparate devices.

At act 210, security engine 102, based on second metadata representing at least one defined time range associated with data resources stored on storage equipment, can determine whether or not the user identity is permitted access to at least one data resource of the data resources. In regard to the second metadata, the second metadata can represent at least one defined time range during which the authenticated user identity is permitted access to at least one of the data resources stored to the storage equipment. In regard to the storage equipment, this is but one example of equipment that can be subject to the foregoing authentication and authorization scheme. Other equipment that can beneficially utilize the detailed authentication and authorization scheme can include resource equipment (e.g., network resources, print resources, communication resources, processing resources, memory resources, and the like).

Thereafter at act 212, security engine 102, based on the defined access time duration and the time at which the user identity has initiated access to the at least one data resource, security engine 102 can notify the resource that the user identity has been authenticated and authorized to use the resources maintained by the resource equipment.

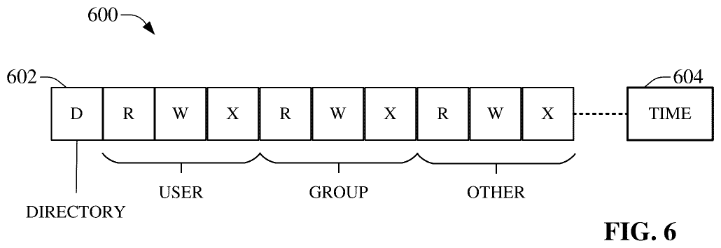

With reference to FIGS. 6, 7, and 8, presented therein are depictions of metadata 600, 700, and 800. Metadata 600, 700, and 800 can comprise first metadata 602, 702, and 802 and second metadata 604, 704, and 804. First metadata 602, 702, and 802 can comprise a first collection of attributes representing access permissions to a resource, in this instance, a directory D. The first collection of attributes can be a first read permission R, a first write permission W, and a first execute permission X. The first permissions (e.g., first read permission R, first write permission W, and first execute permission X) can be grouped and associated with a user identity (e.g., depicted as USER). The first metadata 602, 702, and 802 can also comprise a second collection of attributes comprising a second read permission R, a second write permission W, and a second execute permission X that can be associated with a group of user identities (e.g., depicted as GROUP), wherein the user identity can be a member of the group of user identities. Additionally, as depicted, the first metadata 602, 702, and 802 can comprise a third collection of attributes comprising a third read permission R, a third write permission W, and a third execute permission X that can be associated with other user identities (e.g., depicted as OTHER). Other user identities can include administrative identities, such as system administrative entities (e.g., human identities) and/or system administrative processes that can be in execution.

Second metadata 604, 704, and 804 can comprise one or more defined or definable time durations during which the user identity, the group of user identities, and/or the other user identities can access the resources maintained by resource equipment. As illustrated in FIG. 6 the second metadata 604 can provide time durations during which each of the user identity, the group of user identities, and/or the other user identities can access resources (in this case directory D) maintained by resource equipment. It will be observed in connection with metadata 600 comprising first metadata 602 and second metadata 604, that the resource (e.g., directory D) is generally governed by the specified time durations included in the second metadata 604. Thus for example, should the second metadata define a single time duration (e.g., 08:00-17:00 hours, India Standard Time (IST)) this single time duration can be applicable to each of the first collection of attributes, the second collection of attributes, and/or the third collection of attributes.

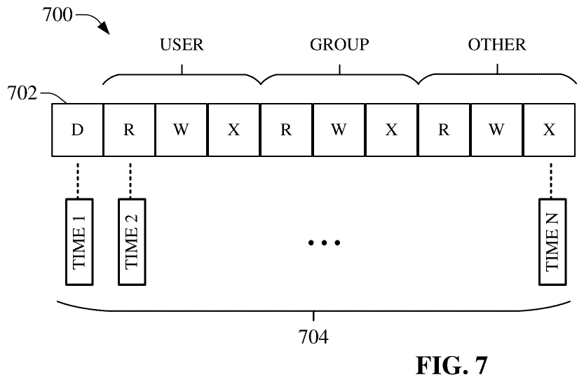

In regard to FIG. 7, the second metadata 704 can comprise individual time durations (e.g., time 1, time 2, . . . , time N, wherein N represents an integer value equal to, or greater, than zero (0)). In accordance with these embodiments, the resource itself (e.g., directory D) can be accorded second metadata (e.g., time 1), wherein access to the resource can be curtailed through use of the second metadata associated with it. For example, a specified access time duration can be imposed, for example for system maintenance rationale, on the use of the resource (e.g., directory D), such as an access time range of between 03:00 and 23:59 hours.

Further, as also depicted, the first read permission (R), the first write permission (W), and/or the first execute permission (X) associated with the USER triplet (or triad) can respectively be associated with individuated and distinct time durations. For example and as depicted in FIG. 7, an individuated time duration (e.g., time 2) can be associated with the first read permission (R). Similar time durations and/or differing/disparate defined time duration ranges can be associated with each of the first write permission (W) and first execute time permission (X). Analogous, but respectively distinct time range durations, where necessary, can be associated with the respective read permissions, write permissions, and execute permission associated with the GROUP triplet, and/or the OTHER triplet. As will be noted by those of ordinary skill the time duration associated with the resource (e.g., directory D) can be govern and be determinative of the differentiated second metadata associated with the each of the read, write, and execute permissions associated with each of the USER triplet, the GROUP triplet, and/or the OTHER triplet. For example, where access to the resource (e.g., directory D), as defined in the second metadata (e.g., time 1) specifies that the resource in only available between 03:00 and 23:59, Monday to Friday, second metadata respectively associated with the read, write, and execute permissions for each of the USER triplet, the GROUP triplet, and/or the OTHER triplet, should comply with the time period defined in the second metadata associated with the resource (e.g., directory D). So, where the specified time duration window for access to resource D is set as being between 03:00 and 23:59, Monday to Friday, the respective second metadata (e.g., time 2 . . . time N) associated with at least one or more of the permissions associated with the USER triplet, the GROUP triplet, and/or the OTHER triplet, typically should not comprise a time duration of 01:30 to 02:59, Saturday and Sunday.

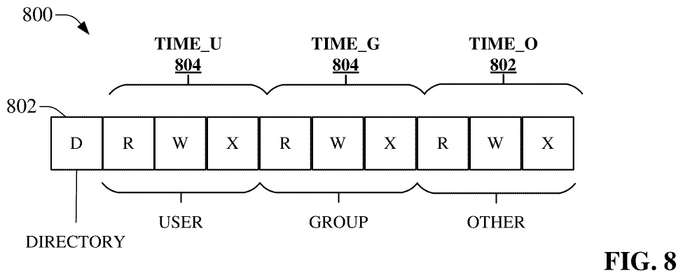

Concerning FIG. 8 and second metadata 804, in additional and/or alternative embodiments the second metadata 804 can respectively be associated with each permission of the USER triad, the GROUP triad, and/or the OTHER triad. Accordingly, a first instance of second metadata 804 can be associated with the USER triad (e.g., Time_U), a second instance of second metadata 804 can be associated with the GROUP triad (e.g., Time_G), and/or a third instance of second metadata 804 can be associated with the OTHER triad (e.g., Time_O). It should be noted that the first instance of second metadata 804 (e.g., Time_U), the second instance of second metadata 804 (e.g., Time_G), and the third instance of the third metadata 804 (e.g., Time_O) can each be differentiable and distinct from one another.

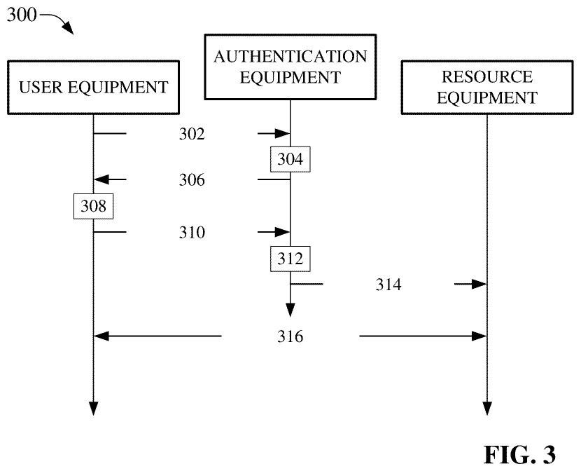

Now with reference to FIG. 3 that illustrates another methodology, time sequence, or method 300 for the implementation of time based file access, in accordance with various example embodiments. Time sequence 300 can commence at act 302 where authentication equipment 100 in conjunction with security engine 102 (illustrated in FIG. 1), can obtain, as user input associated with a user identity, authentication data representing a username and password combination. At act 304, in response to determining that the username and password combination is valid and is associated with the user identity, security engine 102 can, at act 304, for example, based on generated groups of alphanumeric string values of defined lengths, generate and transmit to user equipment associated with the user identity a first authentication code. As has been noted above, security engine 102, at act 304, can use one or more cryptographic techniques, such as hashing algorithms, wherein one or more of attribute associated with the user identity (e.g., user identity name, user identity driving license number, user identity address, and the like) can be used as keys to generate the first authentication code. Also multi-party block chaining algorithms can be used, wherein data, such as nonce strings generated as a function of one or more unique user identity attribute, can be encrypted using respective public/private cryptographic keys from at least three (or more) disparate devices, and the like, in order to generate the first authentication code.

At act 306 the first authentication code generated by security engine 102 can be sent to the user equipment that was used by the user identity to initiate and establish contact with the authentication equipment 100. At act 308 the user equipment, in some embodiments, in response to receiving the first authentication code generated and sent at act 304 by authentication equipment, can simply return the first authentication code and a second authentication code. In additional and/or alternate embodiments, the user equipment, in response to receiving the first authentication code, can use the first authentication code to generate a second authentication code that can be sent back to the authentication equipment 100 (e.g., security engine 102). In order to generate the second authentication code the user equipment can beneficially use analogous hashing processes and/or similar multi-party block chaining processes that were employed by security engine 102 to generate the first authentication code.

At act 310 the user equipment can transmit the second authentication code generated at act 308 back the authentication equipment (e.g., security engine 102). In response to receiving the second authentication code, security engine 102 operational on authentication equipment 100, at act 312, can determine based at least on having received the second authentication code and further based on first metadata associated with the user identity, that the user identity has been validated to access resource server equipment associated with authentication equipment. Further at act 312 security engine 102 can determine based on second metadata associated with resources controlled and maintained by resource equipment (e.g., data resources persisted to storage server equipment) that the user identity is authorized to access at least one of the resources.

At act 314 authentication equipment 100 via security engine 102 can notify resource equipment that the user identity using user equipment is permitted access to the at least one resource controlled and maintained by resource equipment. Thereafter, at act 316 intercommunication between the user equipment associated with the user identity and the resource equipment can be established.

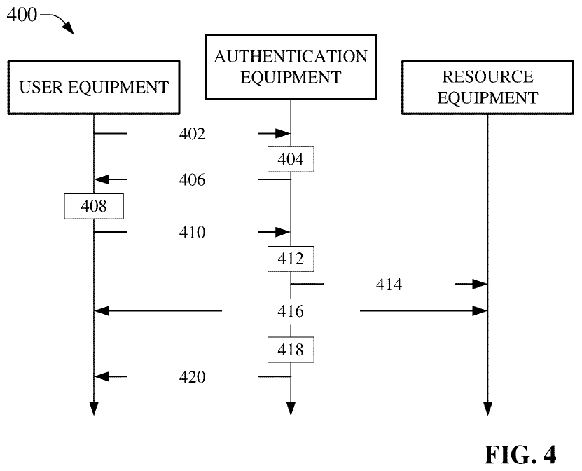

With reference to FIG. 4 that depicts a methodology, process, and/or time sequence chart 400 that can be used to beneficially implement time based file access, in accordance with various described embodiments set forth herein, time sequence chart 400 can begin at act 402 wherein authentication equipment 100 in conjunction with security engine 102 can obtain, as user input associated with a user identity, authentication data representing a username and password combination. At act 404, in response to determining that the username and password combination is valid and is associated with the user identity, security engine 102 can, at act 404, for example, based on generated groups of alphanumeric string values of defined lengths, generate and transmit to user equipment associated with the user identity a first authentication code. As has been noted above, security engine 102, at act 404, can use one or more cryptographic techniques, such as hashing algorithms, wherein one or more of attribute associated with the user identity (e.g., user identity name, user identity driving license number, user identity address, and the like) can be used as keys to generate the first authentication code. Also multi-party block chaining algorithms can be used, wherein data, such as nonce strings generated as a function of one or more unique user identity attribute, can be encrypted using respective public/private cryptographic keys from at least three (or more) disparate devices, and the like, in order to generate the first authentication code.

At act 406 the first authentication code generated by security engine 102 can be sent to the user equipment that was used by the user identity to initiate and establish contact with the authentication equipment 100. At act 408 the user equipment, in some embodiments, in response to receiving the first authentication code generated and sent at act 404 by authentication equipment, can simply return the first authentication code and a second authentication code. In additional and/or alternate embodiments, the user equipment, in response to receiving the first authentication code, can use the first authentication code to generate a second authentication code that can be sent back to the authentication equipment 100 (e.g., security engine 102). In order to generate the second authentication code the user equipment can beneficially use analogous hashing processes and/or similar multi-party block chaining processes that were employed by security engine 102 to generate the first authentication code.

At act 410 the user equipment can transmit the second authentication code generated at act 408 back the authentication equipment (e.g., security engine 102). In response to receiving the second authentication code, security engine 102 operational on authentication equipment 100, at act 412, can determine based at least on having received the second authentication code and further based on first metadata associated with the user identity, that the user identity has been validated to access resource server equipment associated with authentication equipment. Further at act 412 security engine 102 can determine based on second metadata associated with resources controlled and maintained by resource equipment (e.g., data resources persisted to storage server equipment) that the user identity is authorized to access at least one of the resources.

At act 414 authentication equipment 100 via security engine 102 can notify resource equipment that the user identity using user equipment is permitted access to the at least one resource controlled and maintained by resource equipment. Thereafter, at act 416 a communication exchange between the user equipment associated with the user identity and the resource equipment can be initiated. At act 418 security engine 102, using one or more monitoring process executing on authentication equipment 100 (and/or processes in execution on user equipment) and based on one or more defined permissible time range/period (e.g., threshold values) included in the second metadata (see e.g., FIGS. 6-8FG and the respective descriptions concerning second metadata 604, 704, and 804) associated with the user identity, can curtail or reduce access by the user identity to the resources controlled and maintained by resource equipment. Security engine 102 in response to determining that the defined access time period is about to expire, at act 418, can generate a notification providing a rationale for the user identity (or when the user identity is a process in execution, an error code to be entered into one or more error log) as to why access to the resource equipment will be (or has been) partially limited and/or terminated entirely. At act 420 security engine 102, using communication functionalities and/or facilities associated with authentication server 100, can transmit the notification to the user equipment.

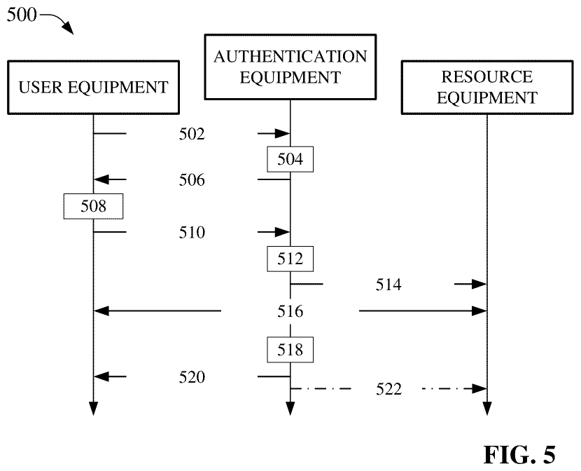

With reference to FIG. 5 that illustrates a methodology, process, and/or time sequence chart 500 that can be used to beneficially implement time based file access, in accordance with various described embodiments set forth herein. Since acts 502 to 520 detailed in FIG. 5 are generally correlative and analogous to actions 402 to 420 outlined in FIG. 4, additional description of actions 502 to 520 are omitted for the sake of brevity and compact exposition. Thus, at action 522, based on the first metadata and the second metadata (see e.g., FIGS. 7 and 8) individual permissions within the respective permission triads can be associated with different defined time windows. For example, the second metadata (e.g., 704) associated with the execute (X) aspect of the OTHER triad can have different defined time window in contrast to the read (R) and write (W) aspects of the OTHER permission triad. For instance, in one or more embodiments, the second metadata respectively associated with the read (R) and write (W) aspects of the OTHER permission triad can each have a defined time range of 08:00 to 17:00 hours, Monday to Friday, whereas the second metadata associated with execution (X) aspect of the OTHER permission triad can have a defined time range of 16:30 to 22:59 hours, Thursday to Saturday. According to this illustrative example, user identities (and/or processes executing under the aegis of disparate user identities) can read (R) and/or write (W) to the resource between the defined time range of 08:00 to 17:00 hours, Monday to Friday, but can only execute (X) the resource within a defined time range of 16:30 to 22:59 hours, Thursday to Saturday. As will be observed, there is a time overlap where the permission to execute (X) the resource extends beyond the permissions to read (R) the resource and write (W) to the resource on Thursdays to Saturdays. Thus, according to this example, at acts 518 and 520, various determinations can be made based to the respective second metadata associated with each of the permission attributes. For instance, authentication equipment 100 (using security engine 102) can at actions 518 and 520, prior to approximately 17:00 hours, Monday to Friday, can send notification to user equipment associated with user identities included in the OTHER permission triad that their read (R) and write (W) access to the resource has expired or will expire (e.g., ACCESS_DENIED), but nonetheless, at action 522 can allow these user identities included in the OTHER permission triad to execute (X) the resource beyond 17:00 hours, Thursday and Friday, and provide these user identities the exclusive capability to execute the resource on Saturday between 16:30 to 22:59. The dotted line connecting authentication equipment and resource equipment at action 522 is representative of the generally conditional nature of this particular action in accordance with the provided example, as such the conditional nature of action 522 should not be construed as being limiting or confining to the general purpose of this disclosure.

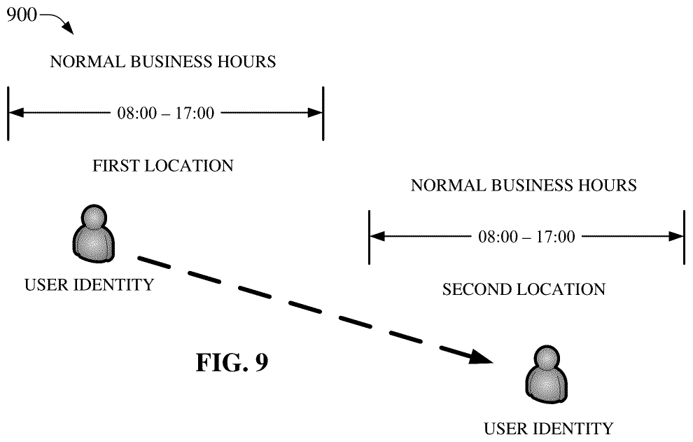

Now concerning FIG. 9 that illustrates an example situation 900 wherein a user identity moves (temporarily) from a first location associated with a first time zone to a second location associated with a disparate second time zone. For example, the user entity can be a travelling corporate executive that has traveled from their corporate head office located at the first location in the first time zone to a subsidiary corporate location situated in the second time zone. For ease of explication rather than limitation, it is assumed that the corporate head office is located within the time zone designated as universal time coordinated (UTC)−5 and the subsidiary corporate location is located within the time zone designated as UTC+7; there is a 12 hour time difference between the corporate head office and the subsidiary corporate office (e.g., 08:00 hours at the corporate head office location is 20:00 hours at the subsidiary corporate location). The travelling corporate executive, being an extremely important individual within the corporate organization, when situated at the corporate head office location typically requires access to corporate data between 08:00-17:00 hours, Monday to Friday, for example.

Now, the travelling corporate executive, having traveled to the time zone within which the subsidiary corporate is located, arrives at the subsidiary corporate location (e.g., second location) at 08:00 hours local time (e.g., UTC+7) and promptly attempts to access resources maintained on resource equipment situated at the corporate head office. Unfortunately, the hours available for them to access the resource is 08:00-17:00 hours (normal business hours) at the first location (e.g., UTC−5). In order to accommodate this situation, security engine 102, for example, can use various time stamp data associated with communication packet data (e.g., data packet header data) to determine that the travelling corporate executive, having successfully gained access to the corporate authentication equipment 100, is nonetheless unable to access resources beyond authentication equipment 100 and maintained by resource equipment located at the first location, because the time for access, as defined by the second metadata associated with the user identity (e.g. traveling corporate executive), does not correspond with actual time of access for the resource associated with the resource equipment (e.g., there is a 12 hour time difference between the corporate head office and the subsidiary corporate office). Security engine 102, in this situation, can use one more data mining processes and/or machine learning processes, to discover patterns, correlations, associated with the traveling corporate executive within massive datasets to determine data such as the veracity of the traveling corporate executive, the normal predicted “normal business hours” that the traveling corporate executive generally maintains, previous travel patterns (e.g., typical locations and seasons in which the traveling corporate executive embarks on traveling to various subsidiary corporate locations), and the like. With this data security engine 102 can dynamically adapt the defined time periods associated with the user identity (e.g., the traveling corporate executive) associated second metadata, to allow the traveling corporate executive access to the resources maintained by the resource equipment in accordance with the normal business hours in the second location.

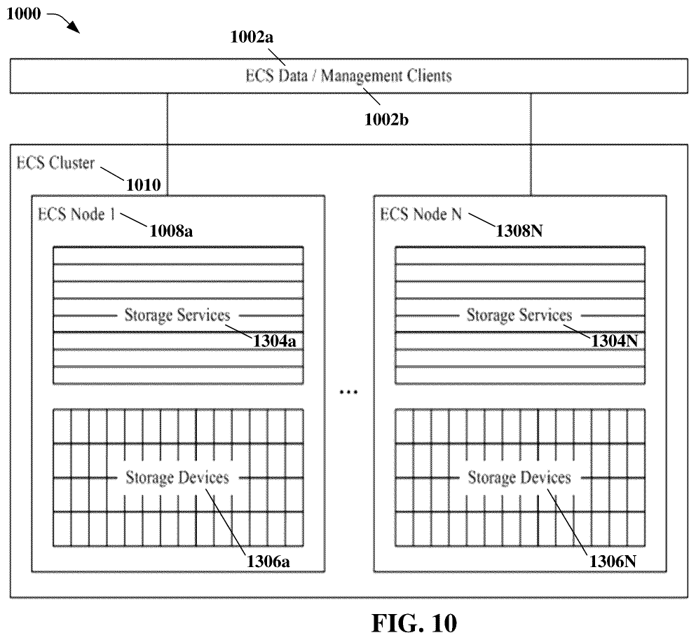

In the following, FIG. 10 describes an example non-limiting cloud storage system in the non-limiting context of an ECS storage system, but for the avoidance of doubt, the subject embodiments can apply to any storage platform. For instance, in this regard, FIG. 10 illustrates an ECS storage system 1000 comprising a cloud-based object storage appliance in which corresponding storage control software comprising, e.g., ECS data client(s) 1002a, ECS management client(s) 1002b, storage service(s) 1004a . . . 1004N, etc. and storage devices 1006a . . . 1006N (e.g., storage media, such as physical magnetic disk media, etc. of respective ECS nodes of ECS cluster 1010) are combined as an integrated system with no access to the storage media other than through the ECS storage system 1000.

In this regard, ECS cluster 1010 comprises multiple nodes 1008a . . . 1008N, storage nodes, ECS nodes, etc. Each node is associated with storage devices 1006a . . . 1006N, e.g., hard drives, physical disk drives, storage media, etc. In embodiment(s), ECS node 1008a, or any ECS node, executing on a hardware appliance can be communicatively coupled, connected, cabled to, etc., e.g., 15 to 120 storage devices. Further, each ECS node can execute one or more services for performing data storage operations described herein.

For instance, the ECS storage system 1000 can be an append-only virtual storage platform that protects content from being erased or overwritten for a specified retention period. In particular, the ECS storage system 1000 does not employ traditional data protection schemes like mirroring or parity protection. Instead, the ECS storage system 1000 utilizes erasure coding for data protection, wherein data, a portion of the data, e.g., a data chunk, is broken into fragments, and expanded and encoded with redundant data pieces and then stored across a set of different locations or storage media, e.g., across different storage nodes.

The ECS storage system 1000 can support storage, manipulation, and/or analysis of unstructured data on a massive scale on commodity hardware. As an example, the ECS storage system 1000 can support mobile, cloud, big data, and/or social networking applications. In another example, the ECS storage system 1000 can be deployed as a turnkey storage appliance, or as a software product that can be installed on a set of qualified commodity servers and disks, e.g., within a node, data storage node, etc. of a cluster, data storage cluster, etc. In this regard, the ECS storage system 1000 can comprise a cloud platform that comprises at least the following features: (i) lower cost than public clouds; (ii) unmatched combination of storage efficiency and data access; (iii) anywhere read/write access with strong consistency that simplifies application development; (iv) no single point of failure to increase availability and performance; (v) universal accessibility that eliminates storage silos and inefficient extract, transform, load (ETL)/data movement processes; etc.

In embodiment(s), the cloud-based data storage system can comprise an object storage system, e.g., a file system comprising, but not limited to comprising, a Dell EMC® Isilon file storage system. As an example, a storage engine can write all object-related data, e.g., user data, metadata, object location data, etc. to logical containers of contiguous disk space, e.g., such containers comprising a group of blocks of fixed size (e.g., 128 MB) known as chunks. Data is stored in the chunks and the chunks can be shared, e.g., one chunk can comprise data fragments of different user objects. Chunk content is modified in append-only mode, e.g., such content being protected from being erased or overwritten for a specified retention period. When a chunk becomes full enough, it is sealed, closed, etc. In this regard, content of a sealed, closed, etc. chunk is immutable, e.g., read-only, and after the chunk is closed, the storage engine performs erasure-coding on the chunk.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, the terms “logic,” “logical,” “logically,” and the like are intended to refer to any information having the form of instruction signals and/or data that may be applied to direct the operation of a processor. Logic may be formed from signals stored in a device memory. Software is one example of such logic. Logic may also be comprised by digital and/or analog hardware circuits, for example, hardware circuits comprising logical AND, OR, XOR, NAND, NOR, and other logical operations. Logic may be formed from combinations of software and hardware. On a network, logic may be programmed on a server, or a complex of servers. A particular logic unit is not limited to a single logical location on the network.

As utilized herein, terms “component,” “system,” “engine”, and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per sc.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used to determine probabilistic likelihoods that code paths utilize operating system synchronization mechanism, as described herein.

A classifier can be a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of communication equipment, e.g., a server, etc., receiving reports from such communication equipment, receiving operator preferences, receiving historical information, receiving extrinsic information, etc. For example, support vector machines can be configured via a learning or training phase within a classifier constructor and feature selection module. Thus, the classifier(s) can be used by an artificial intelligence system to automatically learn and perform a number of functions, e.g., performed by variance engine 102.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” “data storage,” “database,” “storage medium,” “socket”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in a data storage cluster, non-volatile memory 1122, disk storage 1124, and/or memory storage 1146, further description of which is below. For instance, nonvolatile memory can be included in read only memory (ROM), programmable ROM (PROM), electrically programmable ROM (EPROM), electrically erasable ROM (EEPROM), or flash memory. Volatile memory 1120 can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

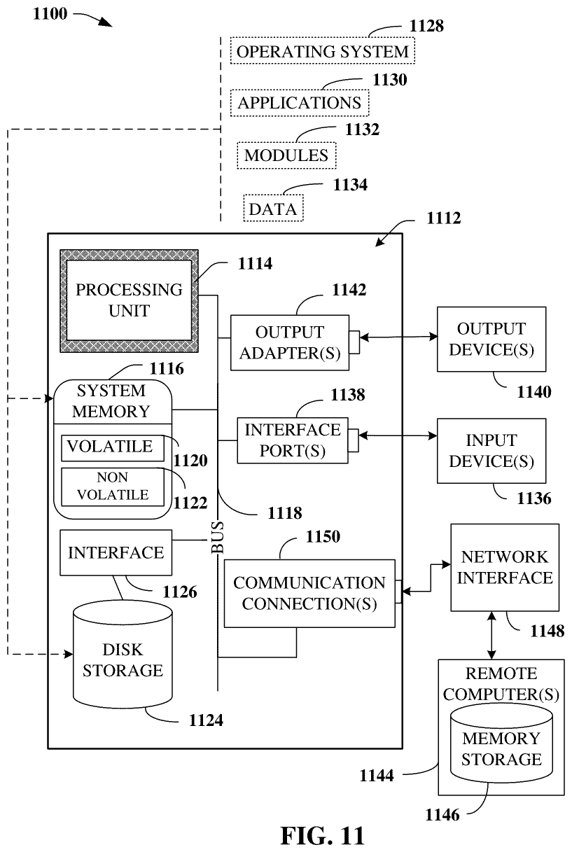

In order to provide a context for the various aspects of the disclosed subject matter, FIG. 11, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 11, a block diagram of a computing system 1100, e.g., system 110, operable to execute the disclosed systems and methods is illustrated, in accordance with an embodiment. Computer 1112 comprises a processing unit 1114, a system memory 1116, and a system bus 1118. System bus 1118 couples system components comprising, but not limited to, system memory 1116 to processing unit 1114. Processing unit 1114 can be any of various available processors. Dual microprocessors and other multiprocessor architectures also can be employed as processing unit 1114.

System bus 1118 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1116 comprises volatile memory 1120 and nonvolatile memory 1122. A basic input/output system (BIOS), containing routines to transfer information between elements within computer 1112, such as during start-up, can be stored in nonvolatile memory 1122. By way of illustration, and not limitation, nonvolatile memory 1122 can comprise ROM, PROM, EPROM, EEPROM, or flash memory. Volatile memory 1120 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1112 also comprises removable/non-removable, volatile/non-volatile computer storage media. FIG. 11 illustrates, for example, disk storage 1124. Disk storage 1124 comprises, but is not limited to, devices like a magnetic disk drive, floppy disk drive, tape drive, Jaz drive, Zip drive, LS-100 drive, flash memory card, or memory stick. In addition, disk storage 1124 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to system bus 1118, a removable or non-removable interface is typically used, such as interface 1126.

It is to be appreciated that FIG. 11 describes software that acts as an intermediary between users and computer resources described in suitable operating environment 1100. Such software comprises an operating system 1128. Operating system 1128, which can be stored on disk storage 1124, acts to control and allocate resources of computer system 1112. System applications 1130 take advantage of the management of resources by operating system 1128 through program modules 1132 and program data 1134 stored either in system memory 1116 or on disk storage 1124. It is to be appreciated that the disclosed subject matter can be implemented with various operating systems or combinations of operating systems.

A user can enter commands or information into computer 1112 through input device(s) 1136. Input devices 1136 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1114 through system bus 1118 via interface port(s) 1138. Interface port(s) 1138 comprise, for example, a serial port, a parallel port, a game port, a universal serial bus (USB), a wireless based port, e.g., Wi-Fi, Bluetooth, etc. Output device(s) 1140 use some of the same type of ports as input device(s) 1136.

Thus, for example, a USB port can be used to provide input to computer 1112 and to output information from computer 1112 to an output device 1140. Output adapter 1142 is provided to illustrate that there are some output devices 1140, like display devices, light projection devices, monitors, speakers, and printers, among other output devices 1140, which use special adapters. Output adapters 1142 comprise, by way of illustration and not limitation, video and sound devices, cards, etc. that provide means of connection between output device 1140 and system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. Remote computer(s) 1144 can be a personal computer, a server, a router, a network PC, a workstation, a microprocessor based appliance, a peer device, or other common network node and the like, and typically comprises many or all of the elements described relative to computer 1112.

For purposes of brevity, only a memory storage device 1146 is illustrated with remote computer(s) 1144. Remote computer(s) 1144 is logically connected to computer 1112 through a network interface 1148 and then physically and/or wirelessly connected via communication connection 1150. Network interface 1148 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1150 refer(s) to hardware/software employed to connect network interface 1148 to bus 1118. While communication connection 1150 is shown for illustrative clarity inside computer 1112, it can also be external to computer 1112. The hardware/software for connection to network interface 1148 can comprise, for example, internal and external technologies such as modems, comprising regular telephone grade modems, cable modems and DSL modems, wireless modems, ISDN adapters, and Ethernet cards.

The computer 1112 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1112 can connect to other devices/networks by way of antenna, port, network interface adaptor, wireless access point, modem, and/or the like.

The computer 1112 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating there from. Therefore, the disclosed subject matter should not be limited to any single embodiment described herein, but rather should be construed in breadth and scope in accordance with the appended claims below.

What is claimed is:

1. Authentication equipment, comprising:
at least one processor; and
at least one memory that stores executable instructions that, when executed by the at least one processor, facilitate performance of operations, comprising:
obtaining, from user input associated with a user identity, authentication data representing a username and password combination;
in response to determining that the username and password combination is valid and is associated with the user identity, determining, based on first metadata associated the user identity, that the user identity is authorized to access storage server equipment associated with the authentication equipment; and
determining, based on second metadata associated with data resources stored on the storage server equipment, that the user identity is permitted access to at least one of the data resources.

2. The authentication equipment of claim 1, wherein the operations comprise, prior to determining that the username and password combination is valid, generating and transmitting, to a user device associated with the user identity, a first authentication code, and receiving, in response to the transmitting of the first authentication, a second authentication code that confirms that the username and password combination is valid.

3. The authentication equipment of claim 1, wherein the first metadata comprises one or more permissions for access to the data resources stored on the storage server equipment.

4. The authentication equipment of claim 1, wherein the second metadata represents at least one defined time range during which the user identity is able to access the at least one of the data resources stored on the storage server equipment.

5. The authentication equipment of claim 4, wherein the at least one defined time range is determined based on a quality of service metric data representative of a quality of service metric associated with the user identity.

6. The authentication equipment of claim 5, wherein the at least one defined time range is determined based on a historical pattern of use of the at least one of the data resources in association with the user identity.

7. The authentication equipment of claim 1, wherein the first metadata and the second metadata are associated with the data resources stored on the storage server equipment.

8. A method, comprising:
receiving, by an authentication server comprising at least one processor from user input associated with a user identity, authentication data representing at least one user access credential;
in response to determining that the at least one user access credential is valid and is associated with the user identity, determining, based on first metadata associated the user identity, that the user identity is authorized to access storage equipment associated with the authentication server; and
determining, based on second metadata associated with data resources stored on the storage equipment, that the user identity is permitted access to at least one data resource of the data resources.

9. The method of claim 8, wherein, prior to determining that the at least one user access credential is valid, generating and transmitting, to a user device associated with the user identity, a first authentication code, and receiving, in response to the transmitting of the first authentication, a second authentication code that confirms that the at least one user access credential is valid.

10. The method of claim 8, wherein the first metadata comprises one or more permissions for access to the data resources stored on the storage equipment.

11. The method of claim 8, wherein the second metadata represents at least one defined time range during which the user identity is able to access the at least one of the data resources stored on the storage equipment.

12. The method of claim 11, wherein the at least one defined time range is determined based on a quality of service metric data representative of a quality of service metric associated with the user identity.

13. The method of claim 12, wherein the at least one defined time range is determined based on a historical pattern of use of the at least one of the data resources in association with the user identity.

14. The method of claim 8, wherein the first metadata and the second metadata are associated with the data resources stored on the storage equipment.

15. A non-transitory machine-readable medium, comprising executable instructions that, when executed by at least one processor, facilitate performance of operations, comprising:
receiving, from user input associated with a user identity, authentication data representing a user identifier and a user password associated with the user identifier;
in response to determining that the user identifier and the user password are valid and are associated with the user identity, determining, based on first metadata associated the user identity, that the user identity is authorized to access a storage device associated with the authentication server; and
determining, based on second metadata associated with at least one file or at least one directory stored on the storage device, that the user identity is permitted access to the at least one file or the at least one directory.

16. The non-transitory machine-readable medium of claim 15, wherein the operations comprise, prior to determining that the user identifier and the user password are valid, generating and transmitting, to a user device associated with the user identity, a first authentication code, and receiving, in response to the transmitting of the first authentication, a second authentication code that confirms that the user identifier and the user password are valid.

17. The non-transitory machine-readable medium of claim 15, wherein the second metadata represents at least one defined time range during which the user identity is able to access the at least one of the at least one file or the at least one directory stored on the storage device.

18. The non-transitory machine-readable medium of claim 17, wherein the at least one defined time range is determined based on a quality of service metric data representative of a quality of service metric associated with the user identity.

19. The non-transitory machine-readable medium of claim 18, wherein the at least one defined time range is determined based on a historical pattern of use of the at least one of the at least one file or the at least one directory in association with the user identity.

20. The non-transitory machine-readable medium of claim 15, wherein the first metadata comprises one or more permissions for access to the at least one file or the at least one directory stored on the storage device, and wherein the first metadata and the second metadata are associated with the at least one file or the at least one directory stored on the storage device.
